(19) United States
(12) Patent Application Publication
(10) Pub. No.: US 2008/0193889 A1
(43) Pub. Date: Aug. 14, 2008

(54) Device for Filling Pulverized Coal, Anode Firing and Method for Setting Anodes in a Furnace

(75) Inventor: Arnault Berquet, Attiches (FR)

Correspondence Address: DENNISON, SCHULTZ & MACDONALD, 1727 KING STREET, SUITE 105, ALEXANDRIA, VA, 22314, US

(73) Assignee: E.C.L., Ronchin (FR)

(21) Appl. No.: 12/064,139

(22) PCT Filed: Sep. 7, 2006
(86) PCT No.: PCT/FR2006/002060

§ 371 Date: Mar. 6, 2008

(30) Foreign Application Priority Data
Sep. 12, 2005 (FR) 0509270

(51) Int. Cl. F27D 3/00; B65D 25/38; F27D 5/00

(52) U.S. Cl. 432/3; 222/612; 222/181.2; 222/478; 432/6; 432/253

(57) ABSTRACT

Device for filling the pits of a carbon material anode baking furnace with packing material, substantially carbon powder, includes a tank having a body extended by a lower portion forming at least one funnel, wherein at least two outlet orifices permit the packing material to be poured out of the tank and wherein the outlet orifices are substantially aligned, and a device for handling the tank which permits the tank to be moved in a direction perpendicular to the direction in which the outlet orifices are aligned. It is therefore possible to pour the packing material simultaneously into two adjacent pits of a furnace, from the same tank. The device is used for the baking of anodes used for the electrolysis of aluminum.

This invention relates to a device for filling baking furnace pits with packing material. More particularly, it relates to a device for filling with packing material the pits of a furnace for baking anodes used for the electrolysis of aluminium. The invention also relates to an anode baking installation and a process for placing the anodes in the pits of a furnace so that they may be baked.

The anodes used to produce metal aluminium using the Hall Herault process (which is to say by electrolysis of the alumina in solution in an electrolytic bath) are obtained by moulding a carbonated paste and by heat treating it at a temperature of around 1200° C.

The baking is carried out in furnaces most often comprising several adjacent chambers which themselves are divided into pits by heating partition walls inside which circulate air and combustion gases supplied by burners. The anodes to be baked are stacked in the pits and are entirely submerged in a granular or powdery material called packing material. The packing material protects the anodes during the baking, particularly from oxidation to that they could be submitted due to the high baking temperature.

When it is not inside the pits, the packing material is kept in a tank comprising an outlet duct. The tank is attached to an overhead crane that can be moved above the furnace to position the outlet duct above each pit to be filled.

During the baking cycle, the burners are progressively moved with respect to the chambers so that each anode load, in a given chamber, is successively preheated, undergoes the baking and then is cooled down. This type of furnace is called a ring furnace. Once the anodes have cooled down, they are taken out of the pits. The packing material contained in these pits is sucked up and then placed back in the tank to fill later another pit.

The rate of output of anodes in the baking installations needs to be very high. The electrolysis factories, generally located close to the baking installations, comprise a large number of electrolysis cells (for example several hundred). In each electrolysis cell several anodes are housed, or even several dozen anodes, which are progressively consumed by the electrolysis, on average in around twenty days.

The furnaces and the various equipment required for the baking of the anodes operate on a permanent basis. In particular, the system for filling the pits with packing material, which is to say the packing material tank and the various associated devices (valves, suction systems, overhead crane, etc.) is constantly used. Consequently, this system runs a very high risk of wear and dysfunction. It therefore requires considerable maintenance that can lead to temporary stoppages of the anode baking installation, which is obviously not desirable.

The invention aims to overcome the above disadvantages by extending the working life of the system for filling the pits with packing material, without reducing the anode rate of output.

To this end, and according to one first aspect, the invention relates to a device for filling with packing material the pits of a furnace for baking anodes used for the electrolysis of aluminium, characterised in that it comprises:

a) a tank capable of holding said packing material, said tank comprising a body extended by a lower portion forming at least one funnel, wherein at least two outlet orifices permit the packing material to be poured out of the tank, wherein said outlet orifices are substantially aligned,

b) a device for handling said tank that permits said tank to be moved in a direction perpendicular to the direction in which the outlet orifices are aligned.

The handling device is typically a moving gantry suspended from a carriage that moves along the beam of an overhead crane. Said tank is attached to the suspended moving gantry. In this way, the latter can be moved in two orthogonal directions to a position located just above an anode baking furnace so that the outlet orifices are positioned above the pits of the furnace to be filled. By moving the tank in a direction that is perpendicular to the alignment of the orifices and by arranging it so that this direction is the same as the longitudinal direction of the furnace pits, it is possible to pour simultaneously the packing material via said orifices along said pits. Advantageously, a separate outlet duct is associated to each outlet orifice and permits the packing material flow poured into the pit to be guided.

The result is a significant time saving as several pits can be filled at the same time. Thus, for a number n of orifices, the time required to fill n pits is substantially the same as the time required in the prior art to fill a single pit, as due to the presence of a single outlet duct, it was necessary to fill said pits one after the other. We can therefore divide by n the rate of use of the pits packing material filling system, while maintaining the same rate of output for the anodes. The result is a noticeable drop in the operating and maintenance costs.

The solution provided by the invention has moreover many advantages with respect to other solutions which could have been envisaged to obtain this result:
a simple design of tank and associated devices, hence a lower production cost:
the size of the filling system and the number of devices specifically associated to the tank (opening for filling, etc.) is substantially unchanged, as only one tank is required to fill several pits;
there are no fundamental modifications to the general structure of the tank, except for the outlet orifices. There is consequently no need to make major modifications to the anode baking installation to accommodate this new type of tank;
for orifices that are substantially identical and are positioned symmetrically in the tank, a similar packing material flow is obtained through the various outlet orifices, in terms of speed, granulometry and distribution of the powders. To this end, it is not necessary to equip the tank with any internal system for distributing the packing material, which further simplifies the structure of the tank. Consequently, the filling of n pits is substantially identical.

In one possible embodiment, the funnel has a plane of symmetry that is substantially orthogonal to the direction of alignment of the orifices. There is thus a symmetry of the funnel itself as well as a symmetrical distribution of the orifices.

Preferably, the body of the tank has an elongated shape, typically cylindrical or prismatic, and has an axis that is substantially vertical.

In one possible embodiment, the funnel has, when it is viewed in a direction perpendicular to the plane formed by the substantially vertical axis and the direction of alignment of the orifices, lateral edges that form with said axis an angle that is less than or equal to 50°, and preferably less than or equal to 40°.

Furthermore, the funnel may have, when it is viewed in cross section in a plane perpendicular to the direction of alignment of the orifices and passing via the axis that is substantially vertical, lateral edges which, in one possible embodiment, form different angles with said axis.

Typically, the lateral edges of the funnel are straight lines. The outlet orifices may be substantially circular. In one possible embodiment, the funnel comprises two outlet orifices that are substantially identically shaped.

According to the invention, the tank comprises a plurality of outlet orifices that are each associated to an outlet duct. Advantageously, the outlet ducts are substantially rectilinear and parallel to one another.

The device may comprise, for each outlet duct, a valve capable of closing said duct, wherein the valve has a closing time preferably of less than 12 seconds, or even less than 4 seconds. By “closing time”, we mean the minimum time required by the valve to move from its open position to its closed position.

In another aspect, the invention relates to an anode baking installation, comprising a furnace with a plurality of elongated pits designed to accommodate the anodes and at least one filling device such as that previously described, positioned above the furnace, characterised in that said handling device moves said tank in the longitudinal direction of the pits and in that said outlet orifices are positioned with respect to one other to permit simultaneous filling of at least two separate pits.

Advantageously, a separate outlet duct is associated to each outlet orifice and permits the flow of packing material poured into the corresponding pit to be guided.

For example, the furnace comprises at least one chamber comprising a plurality of substantially identical elongated pits positioned substantially parallel to one another and spaced regularly with respect to one another, and the outlet orifices are substantially aligned, wherein the distance D between two successive orifices is more or less equal to N times the distance d between two adjacent pits, where N is an integer preferably between 1 and 3, and the ducts are laid out so as to simultaneously guide packing material flows into each of the pits. Advantageously, they are substantially rectilinear, vertical and are positioned in a vertical plane substantially perpendicular to the pits.

The funnel may comprise exactly two outlet orifices each associated to an outlet duct, wherein the distance between the two ducts is substantially equal to the distance between two adjacent pits.

In yet another aspect, the invention relates to a process for placing the anodes in the pits of a furnace so that they may be baked, comprising steps consisting of:
providing an anode baking installation such as that previously described, wherein the tank contains packing material and the filling device is positioned so that at least two orifices are positioned opposite a pit;
pouring packing material by at least two orifices positioned opposite a pit, while moving the filling device in the longitudinal direction of the pits, typically from one end of the pits to the other, in order to form in at least two pits a layer of packing material with a thickness that is substantially uniform and low with respect to the height of said pits;
stacking anodes in said pits, wherein the anodes rest on the layer of packing material;
pouring packing material via said orifices while moving the filling device in the longitudinal direction of the pits, in order to fill up the free space between the stacked anodes and the walls of each of said pits.

Advantageously, a separate outlet duct is associated to each outlet orifice which permits the packing material flow to be guided when poured into the corresponding pit. The duct may be moved or deformed (telescopic duct) such that its open end may be moved vertically.

The process may moreover comprise steps consisting of:
providing, for each outlet duct, a valve capable of sealing said duct, wherein the valve has a closing time of preferably less than 12 seconds;
during the steps when the packing material is poured, actuating the duct valves concerned so that the difference in packing material flow rate between the various ducts through which the packing material is poured does not exceed 10%. It should be noted that the distribution of the packing material may be naturally made homogenous in the various ducts, the valves are only to correct any possible difference that is too high.

We will now describe, by way of non restrictive example, one possible embodiment of the invention, with reference to the appended figures:

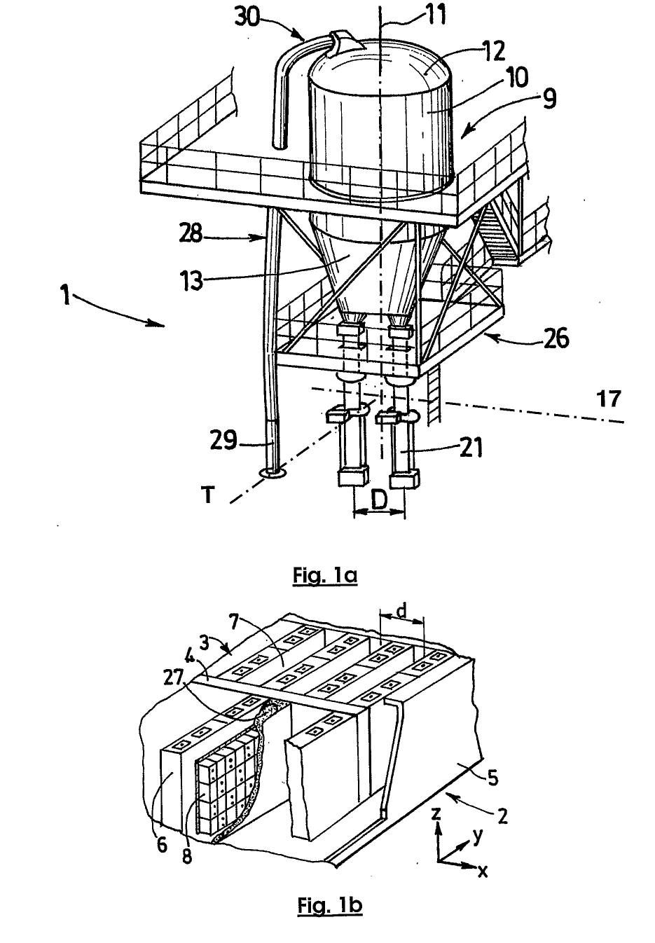

FIGS. 1a and 1b are partial diagrammatical views in perspective of an anode baking installation, showing one the one hand (FIG. 1a) the filling device mounted on a gantry suspended from an overhead crane, and on the other hand (FIG. 1b) the furnace with the pits;

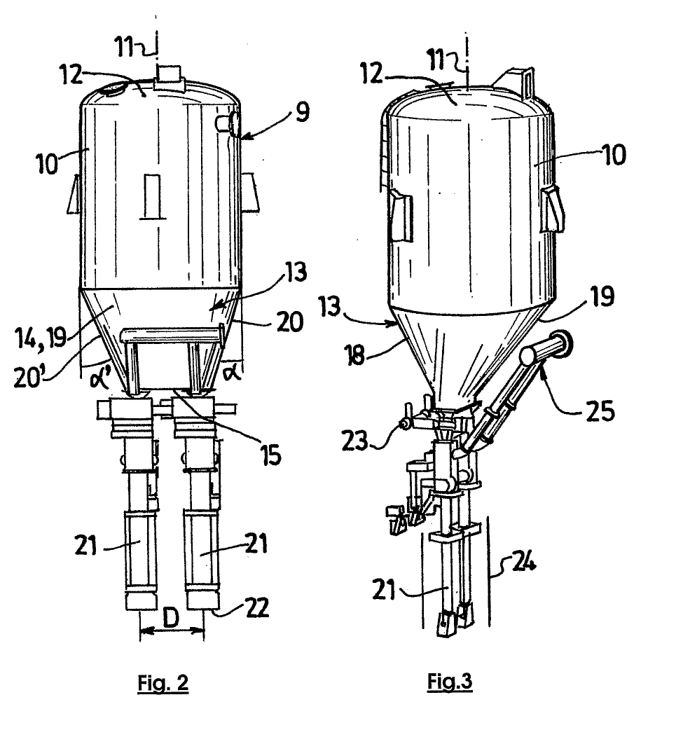

FIG. 2 is a simplified view of the filing device of FIG. 1a, viewed from the rear;

FIG. 3 is a simplified lateral view of the filing device of FIG. 1a;

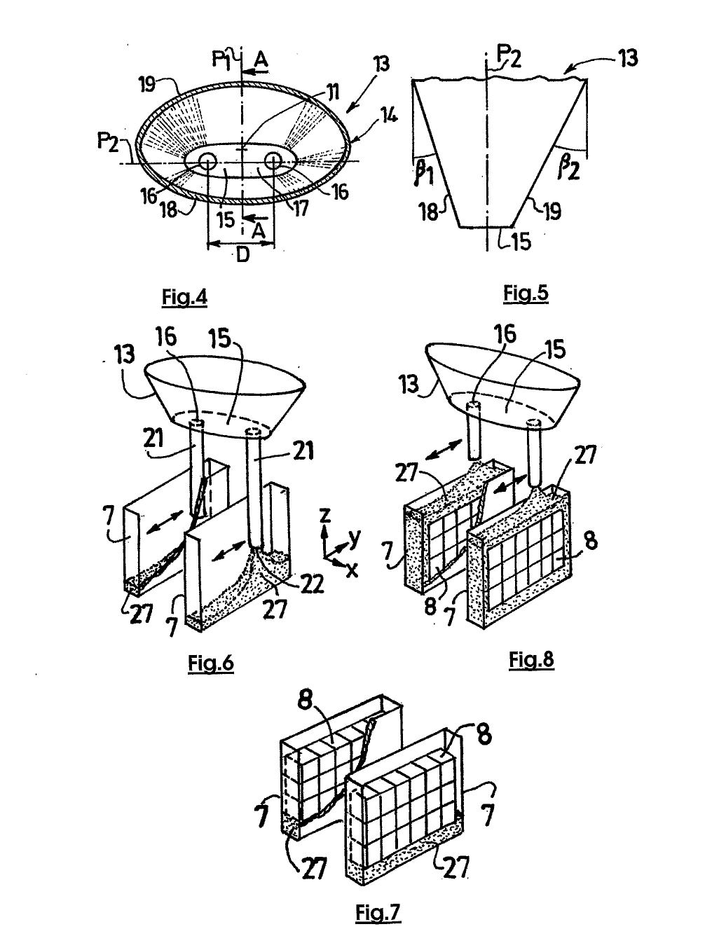

FIG. 4 is a diagrammatical representation of the inside of the tank of a filling device of the invention, wherein the funnel has been sectioned in a substantially horizontal plane;

FIG. 5 partially shows the tank funnel of FIG. 4, viewed in cross section along the line AA; and

FIGS. 6 to 8 show diagrammatically three steps of the process for placing the anodes in two adjacent pits.

FIG. 1 shows an anode baking installation. Installation 1 comprises firstly a ring furnace 2 comprising several chambers 3 positioned longitudinally (x axis), separated by longitudinal walls 4 and limited longitudinally by transversal walls 5. Each chamber 3 comprises a succession of heating partition walls 6 inside which circulate air and combustion gases supplied by burners (not shown). The burners are mounted above the furnace 2 on a moving system that a service machine progressively moves with respect to the chambers 3 during the baking cycle. Between two heating partition walls 6 a pit 7 is designed to accommodate the carbon material anodes 8 so that they can be baked.

The z axis is defined as the ascending vertical, and the y axis forms with z and x a direct orthogonal reference, wherein the y axis is parallel to the length of the pit 7.

The pits 7 of a chamber 3 are regularly spaced with respect to one another, wherein the distance d between two adjacent pits 7 (which is to say the longitudinal distance between the median transversal planes of the pits 7) is substantially constant. By way of example, d may be around 1.5 m.

The installation 1 also comprises a device for filling the pits 7 with packing material. This device comprises a tank 9 comprising a substantially cylindrical body 10 positioned in the installation 1 so that its axis 11 is substantially vertical. The upper end of the body 10 is sealed by a dome 12 and, in the lower half, the body 10 is extended by a lower portion of the tank 9 forming the funnel 13.

The funnel 13 has a lateral wall 14 converging from its upper open circular end to its lower open oblong end. The funnel 13 further has a substantially flat transversal wall orthogonal to the axis 11, forming a bottom 15, whose shape matches the oblong contour of the lower end of the lateral wall 14.

In the bottom 15 there are two orifices 16 which are substantially circular and identical. The orifices 16 are each situated close to one end of the bottom 15, wherein the line 17 joining the centres of the orifices 16 is substantially parallel to the direction of the extension of the bottom 15 and forms the median line of said bottom 15.

The funnel 13 has a plane of symmetry P1 orthogonal to the line 17. In return, the line 17 is transversally offset with respect to the axis 11. With respect to the P2 plane parallel to the axis 11 passing through the line 17, the lateral wall 14 comprises a first part 18 that is substantially in one portion a truncated cone and a second part 19 also substantially in one portion a truncated cone, but with a larger angle at its summit. In other words, viewed in cross section along the P1 plane (and any other plane parallel to P1 not passing through the ends of the lateral wall 14), the lateral wall 14 has lateral edges forming with the vertical axis angles β1 and β2 that are different from one another (see FIG. 5).

Viewed orthogonally to the P2 plane, the lateral wall 14 has lateral edges 20, 20′ which form with the vertical plane an angle α less than or equal to 50° (see FIG. 2). As a variant, one of the lateral edges 20 is sloped at an angle α and the other lateral edge 20′ is sloped at an angle α′ different to α, for reasons of layout of the filling device and the overhead crane. In this case, the P1 plane is no longer a plane of symmetry of the lateral wall 14 but remains a plane of symmetry for the bottom 15.

An outlet duct 21 is associated to each of the orifices 16. Each duct 21 is substantially rectilinear and extends vertically from the bottom 15 downwards to a lower end 22. The distance D between the two lower edges 22 of the ducts 21 (in this case the distance D between the two orifices 16) is in the case shown substantially equal to the distance between two adjacent pits.

Each duct 21 is equipped with a valve 23 controlled separately, for example a double pitch electrical or pneumatic type, whose closing time is very quick, for example less than 12 seconds. Furthermore, a sheath 24 is placed around the ducts 21 and connected to a dust suction device 25 (see FIG. 3).

The tank 9 equipped with its ducts 21 is mounted on a gantry 26, or more precisely is attached to a system of walkway bridges fastened to one another and positioned at different levels of the tank. This gantry 26 is suspended from a carriage which moves along an overhead crane above the furnace 2, so that the tank can be moved in the x and y directions. The tank is attached to the gantry so that the alignment direction 17 of its outlet ducts is parallel to the y direction. The ducts 21 can be removed, and may for example be telescopic, and can thus be moved in the z direction. The tank 9 is designed to contain packing material 27 and to pour it into the pits 7 as we will see below. Its capacity is substantially identical to that of the tanks of the prior art which only had a single outlet duct. The size is consequently unchanged. On the gantries 26 there is fitted a removable tube 28, which for example may be telescopic, for collecting the packing material 27, comprising in its lower half a suction tube 29 and in its upper half an evacuation duct 30 leading to the tank 9 at the dome level 12.

We will now describe the process for placing the anodes 8 in the pits 7 of the furnace 3 for their baking, in reference to FIGS. 6 to 8. By moving the overhead crane, the tank 9 containing the packing material 27 is brought above the pits 7 in which the baking is to be carried out. The two ducts 21 are opposite two adjacent empty pits 7. The tank 9 is lowered so that the ducts 21 each enter a pit 7. The ends of the two ducts 21 are then moved vertically downwards (for example by extending down in the case of telescopic tubes) and each enters a pit 7. The speed of the horizontal movement of the tank 9 is slow, of the order of 4 m/min. The valves 23 are opened, the packing material 27 is poured into the bottom of the pits 7 (FIG. 6).

The symmetry of the funnel 13 with respect to the P1 plane ensures even distribution of the packing material 27 between the two orifices 16 and substantially identical flows. The packing material flows in the two ducts 21 are substantially identical with a tolerance of around 10% difference between the two flows. This result is obtained even without the use of any distribution device in the tank 9, as shown in particular in FIG. 4 (nor any distribution ribs, nor a central cone between the two orifices 16, etc.). However, if required, the flows may be adjusted by actuating either of the valves 23 to reduce the difference further.

The packing material 27 is poured accompanied by a translation movement of the tank 9 in the longitudinal y direction of the pits 7. In this way at the bottom of each pit 7 we obtain a substantially uniform thickness. This ensures good stability of the anodes 8 and thus good baking of them. Furthermore, the even distribution of the flows between the two ducts 21 permits substantially identical layers to be obtained in the two pits 7.

Then the anodes 8 to be baked are stacked in the pits 7, on the layer of packing material 27 (FIG. 7). We then pour packing material 27 again into the two pits 7, simultaneously thanks to the two ducts 21, in order to fill the space between the anodes 8 and the walls of each pit 7 (FIG. 8). Firstly the vertical spaces between the anodes 8 and the end walls of the pits 7 are filled, by moving the ducts 21 vertically. Then a horizontal layer is poured on top of the anodes the ducts having been moved parallel to the y axis.

The packing material, essentially composed of carbon powder, permits especially to shield the anodes from the combustion gases which could cause losses due to oxidation and to separate the anodes in order to limit the risks of agglomeration or the anodes sticking to one another.

Once the anodes have been inserted, the burner is moved close to the pits containing the anodes 8 and the packing material 27 and the baking is carried out. When the baking is complete, the burner is moved towards other pits. After cooling, the packing material 27 surrounding the baked anodes 8 is sucked up by the suction tube 29 to the tank 9 via the evacuation duct 30 so that it can be used again. The baked anodes 8 can then be removed.

As the tank 9 has substantially the same capacity as the tanks of the prior art equipped with a single outlet duct, it needs to be filled more often. However the invention remains advantageous as the filling time of the pits of a chamber is reduced (even if the packing material pouring speed outside of the tank is substantially identical to that of the tanks of the prior art), and the filling operation is not what restricts the rate of output.

Of course, depending on requirements, it is possible by actuating the valves 23 to close one of the ducts 21 in order to fill just one pit at a time, even thought the advantage of the invention lies in the simultaneous filling of several pits.

Variants could consist of:
making a space D between the ducts 21 equal to 2 d or 3 d to permit one pit out of two or out of three to be filled;
providing more than two orifices 16 on the tank 9, to permit simultaneous filling of 3 pits or more, for example that are adjacent.

Obviously the invention is not restricted to the embodiment described here by way of example but on the contrary it covers all of the various embodiments.

1. Device for filling with packing material the pits of a furnace for baking anodes used for the electrolysis of aluminium, comprising:
a) a tank capable of holding said packing material, said tank comprising a body extended by a lower portion forming at least one funnel, wherein at least two outlet orifices permit the packing material to be poured out of the tank, wherein said outlet orifices are substantially aligned, and
b) a device for handling said tank which permits said tank to be moved in a direction perpendicular to the direction in which the outlet orifices are aligned.

2. Filling device according to claim 1, wherein it also comprises an outlet duct (21) associated to each outlet orifice.

3. Filling device according to claim 1, wherein said tank is mounted on a gantry suspended from a carriage which moves along an overhead crane.

4. Filling device according to any of claim 1, wherein the funnel has a plane of symmetry (P1) that is substantially orthogonal to the direction of alignment of the orifices.

5. Filling device according to claim 1, wherein the body (10) of the tank has an axis that is substantially vertical and in that when it is viewed in a direction perpendicular to the plane formed by the axis and the direction of alignment of the orifices, the funnel has lateral edges that form with the axis an angle (α, α′) that is less than or equal to 50°

6. Filling device according to claim 1, wherein the body of the tank has an axis that is substantially vertical and in that, when it is viewed in cross section in a plane perpendicular to the direction of alignment of the orifices and passing through the axis, the funnel has lateral edges which form different angles (β1,β2) with the axis.

7. Filling device according to claim 2, in which the outlet ducts are substantially rectilinear and parallel to one another.

8. Filling device according to claim 2, wherein it comprises, for each outlet duct, a valve capable of closing said duct, wherein the valve has a closing time of less than 12 seconds.

9. Anode baking installation comprising a furnace with a plurality of elongated pits designed to accommodate the anodes and at least one filling device according to claim 1, positioned above the furnace, wherein said handling device moves said tank in the longitudinal direction (y) of the pits and in that said outlet orifices are positioned with respect to one other to permit simultaneous filling of at least two separate pits.

10. Installation according to claim 9, wherein outlet ducts are associated to each of the outlet orifices.

11. Installation according to claim 10, wherein the furnace comprises at least one chamber comprising a plurality of substantially identical elongated pits positioned substantially parallel to one another and spaced regularly with respect to one another, and in that the outlet orifices are substantially aligned, wherein the distance (D) between two successive orifices is more or less equal to N times the distance (d) between two adjacent pits, where N is an integer, and said ducts are substantially rectilinear, vertical and are positioned in a vertical plane substantially perpendicular to the pits.

12. Installation according to claim 11, wherein N has a value of between 1 and 3.

13. Installation according to claim 9, wherein the funnel comprises exactly two outlet orifices each associated to an outlet duct, wherein the distance (D) between the two ducts is substantially equal to the distance (d) between two adjacent pits.

14. Process for placing anodes in elongated pits of a furnace so that they may be baked, comprising the steps of:
providing an anode baking installation according to claim 9, wherein the filling device is positioned above the furnace so that at least two orifices are positioned opposite a pit;
pouring packing material by at least two orifices positioned opposite a pit, while moving the filling device in the longitudinal direction of the pits, in order to form in at least two pits a layer of packing material with a thickness that is substantially uniform and low with respect to the height of said pits;
stacking anodes in said pits, wherein the anodes rest on the layer of packing material; and
pouring packing material via said orifices while moving the filling device in the longitudinal direction (y) of the pits, in order to fill up the free space between the stacked anodes and the walls of each of said pits.

15. Process of claim 14, wherein outlet ducts are associated to each of the outlet orifices.

16. Process of claim 15, wherein the open end of said outlet ducts is also moved vertically to help fill up the free space between the stacked anodes and the walls of each said pits.

17. Process of claim 15, it further comprising the steps of:
providing, for each outlet duct, a valve capable of sealing said duct, wherein the valve has a closing time of preferably less than 12 seconds; and
during the steps when the packing material is poured, actuating the duct valves concerned so that the difference in packing material flow rate between the various ducts through which the packing material is poured does not exceed 10%.
